(19) United States
(12) Patent Application Publication
(10) Pub. No.: US 2007/0243045 A1
(43) Pub. Date: Oct. 18, 2007

(54) Quick die-change collet clamp

(76) Inventor: James Michael Gaska, Nicholasville, KY (US)

Correspondence Address: STOCKWELL & SMEDLEY, PSC, 861 CORPORATE DRIVE, SUITE 200, LEXINGTON, KY, 40503, US

(21) Appl. No.: 11/650,092

(22) Filed: Jan. 5, 2007

Related U.S. Application Data
(60) Provisional application No. 60/786,559, filed on Mar. 28, 2006.

(51) Int. Cl. F16B 37/08

(52) U.S. Cl. 411/432

(57) ABSTRACT

A clamp for use in forming parts is disclosed. The clamp is durable and easily installed, thereby resulting in superior efficiency.

### CROSS-REFERENCE TO RELATED APPLICATIONS

This application claims priority to U.S. Provisional Application No. 60/786,559 which was filed on Mar. 28, 2006.

### FIELD OF THE INVENTION

This invention relates generally to a clamp for use within a press used to form parts, and more specifically to a durable and easily installed clamp which has superior efficiency.

### BACKGROUND OF THE INVENTION

Presses used in forming parts usually require the use of clamps in order to hold the dies (workpieces) that form those parts. However, it can be difficult to install and remove these clamps, as they are subject to a significant amount of mechanical stress and thus must be carefully installed. Consequently, an improved clamp for attachment to a press used in forming parts is desired.

### SUMMARY OF THE INVENTION

It is an object of the present invention to provide a clamp for use in a press that is durable, but can also be installed and removed quickly. It is an additional object of the present invention to do so using a variety of implementations, including but not limited to an optional heelblock. These and other objects and advantages of the invention will become readily apparent as the following description is read in conjunction with the accompanying drawings.

### BRIEF DESCRIPTION OF THE DRAWINGS

FIGS. 1 and 2 show a first embodiment of the present invention;

FIGS. 3 and 4 show the embodiment of FIGS. 1 and 2 located within a press;

FIG. 5 shows a fastener used within the present invention;

FIGS. 6A-6B show front and top views of a topcap used within the present invention;

FIGS. 7A-7B show front and top views of a clamp bar used within the present invention;

FIGS. 8A-8B show front and top views of a collet used within the present invention;

FIGS. 9A-9B show front and top views of a stem nut used within the present invention;

FIGS. 10 and 11 show a second embodiment of the present invention;

FIGS. 12A-12C show a heelblock used within the embodiment of FIGS. 10-11; and

FIGS. 13 and 14 show side and front views respectively of a press incorporating the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

### The Present Invention (Apparatus)

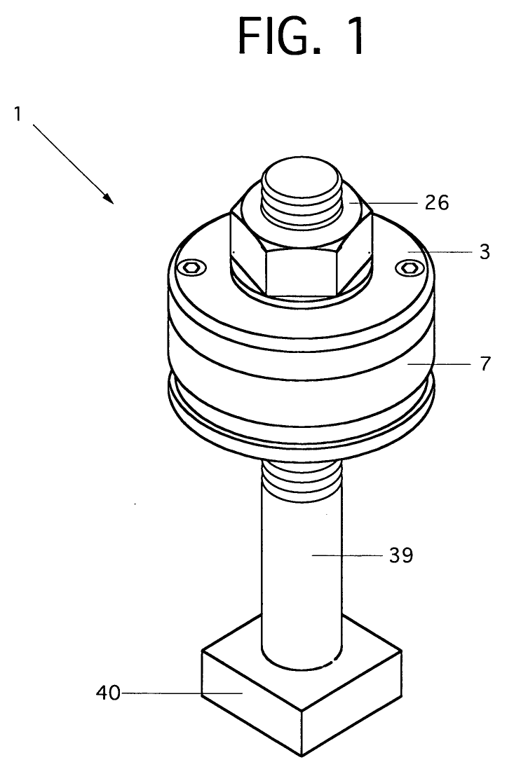

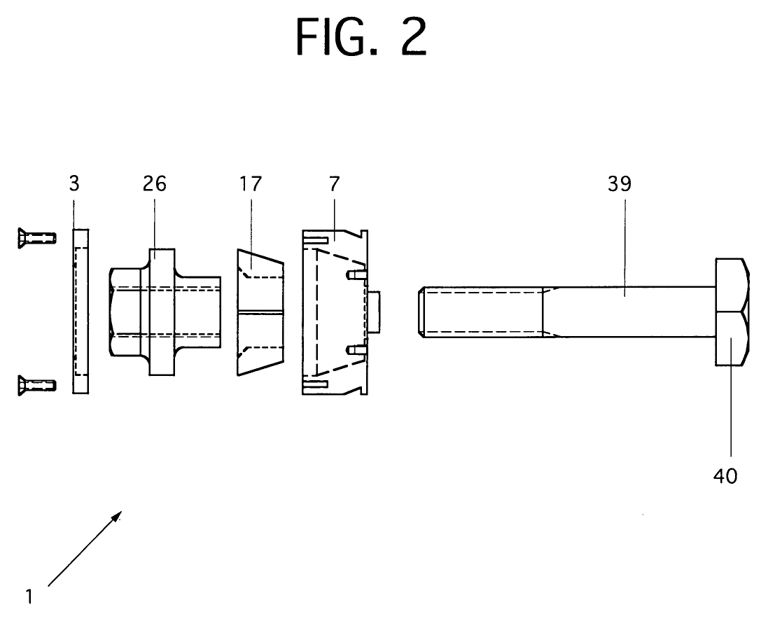

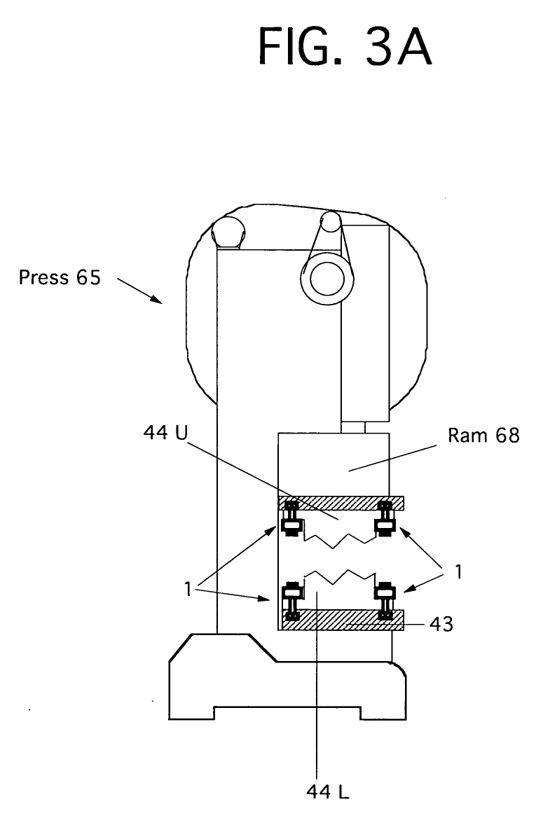

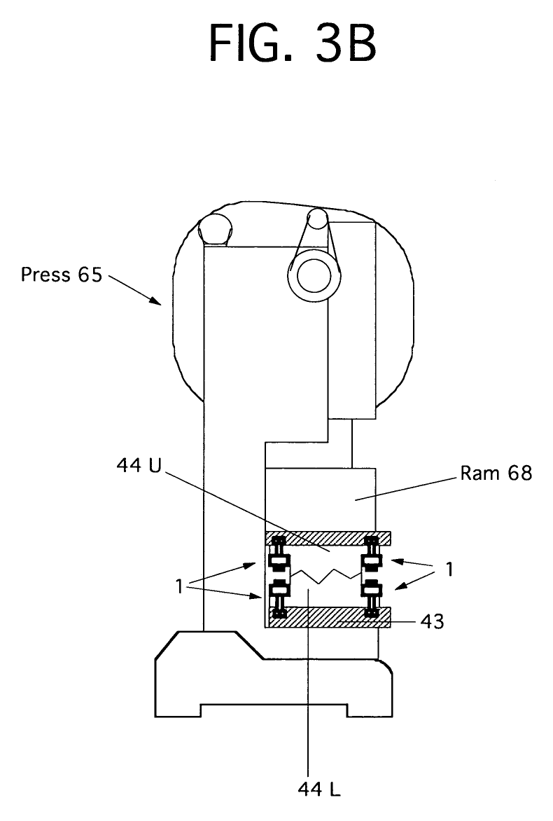

FIGS. 1-4 show a quick die change collet clamp 1 according to the present invention. The clamp 1 is used to secure a workpiece 44 such as a die shoe, die, mold, or fixture to a work surface 43 of a press 65. As shown in FIGS. 2-3, the workpiece 44 has upper and lower halves 44_{U} and 44_{L}. [0001 7] As shown in FIGS. 1 and 2, the clamp 1 comprises a stem nut 26, a topcap 3 for holding the stem nut 26 in position, a clamp bar 7 for securing the workpiece 44, and a head 40, all attached to a fastener 39. FIG. 2 further introduces a collet 1 7.

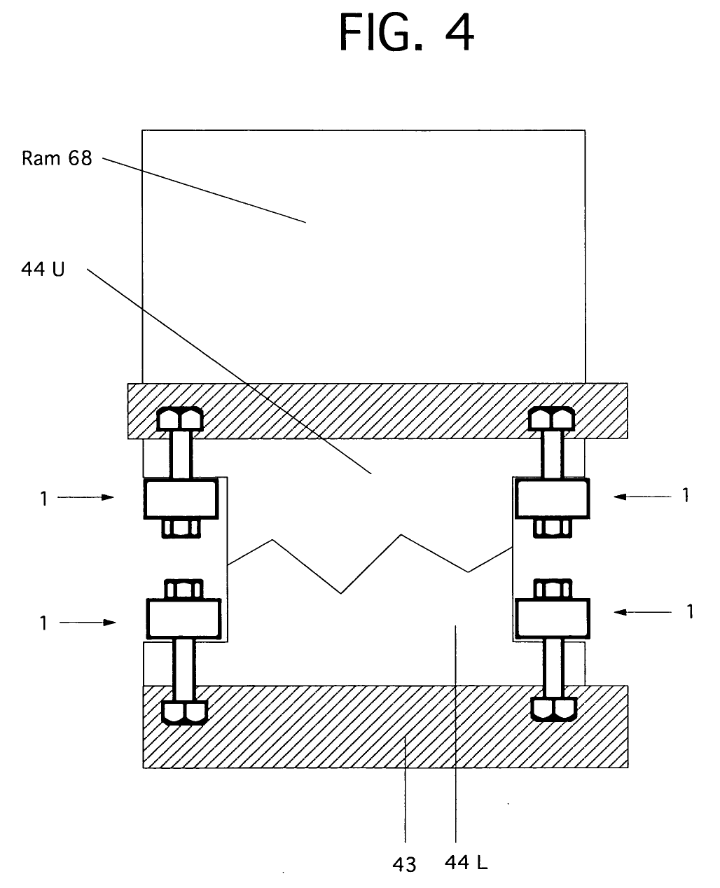

The process of stamping a part is shown in FIGS. 3A-3B and 4. A ram 68 within the press 65 is shown going up and down, thereby opening and closing the workpiece 44. The workpiece 44 is shown in FIGS. 3 and 4 with a jagged edge to illustrate that it is one part of a larger operation, and works in conjunction with and rests on top of the work surface 43 of the press 65. However, this jagged edge is for illustrative purposes only, so that the workpiece 44 and work surface 43 should not be considered as limited only to the exemplary jagged shape. Also, although FIGS. 3A-3B suggest a press 65 having a vertical motion, other directions of motion are also contemplated within the spirit and scope of the present invention

To stamp a part, first, the press 65 is opened by raising the ram 68, as shown in FIG. 3A. This causes the workpiece 44 to separate into upper and lower halves 44_{U} and 44_{L} Different parts made by the press 65 may required different workpieces. Accordingly, the clamps 1 are then adjusted to fit to a specific workpiece 44 useful for making the desired part. Afterwards, strips of raw material are put into the workpiece 44. Then, the press 65 is operated by lowering the ram 68, thereby closing the workpiece 44, forcing the upper and lower halves 44_{U} and 44_{L} together at enormous pressure. When the workpiece 44 is closed, a part (not shown) is then produced. The workpiece 44 is then opened and the part is removed.

The clamp 1 holds the workpiece 44 securely within the press 65 by closely fitting (as shown by the jagged line in FIGS. 3-4) the upper and lower halves 44_{U} and 44_{L} together. It is important that the workpiece 44 be secure within the press 65, because some presses exert as much as 3000 tons onto the workpiece 44. Consequently, the clamp 1 of the present invention must be reliable and extremely durable. However, the clamp 1 must also be easily loosened when it is time to change out the workpiece 44.

Any time spent making adjustments to a clamp is equivalent to time where the press 65 is not in productive use, in other words idle or down-time. It is desired to minimize all down-time, and have the press 65 be in productive economic use as high a percentage of time as possible. The clamp 1 of the present invention reduces such idle or down-time.

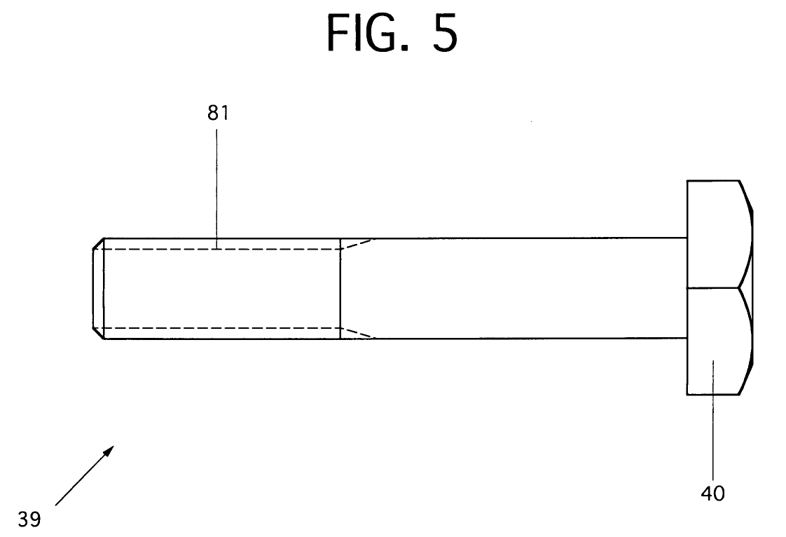

As shown in FIG. 5, the fastener 39 can be but is not limited to a large bolt. Whatever the exact shape, the fastener 39 should have a shaft extending longitudinally with a generally circular cross-section. That shaft will have a threaded portion 81. The threaded end 81 of the shaft may have a diameter other than the diameter of the remainder of the shaft. The fastener 39 also has a head 40 opposite the threaded end 81. This head 40 is generally rectangular or square in cross-section, so as to facilitate slidable movement within the slots 42 of the stamping machine 65.

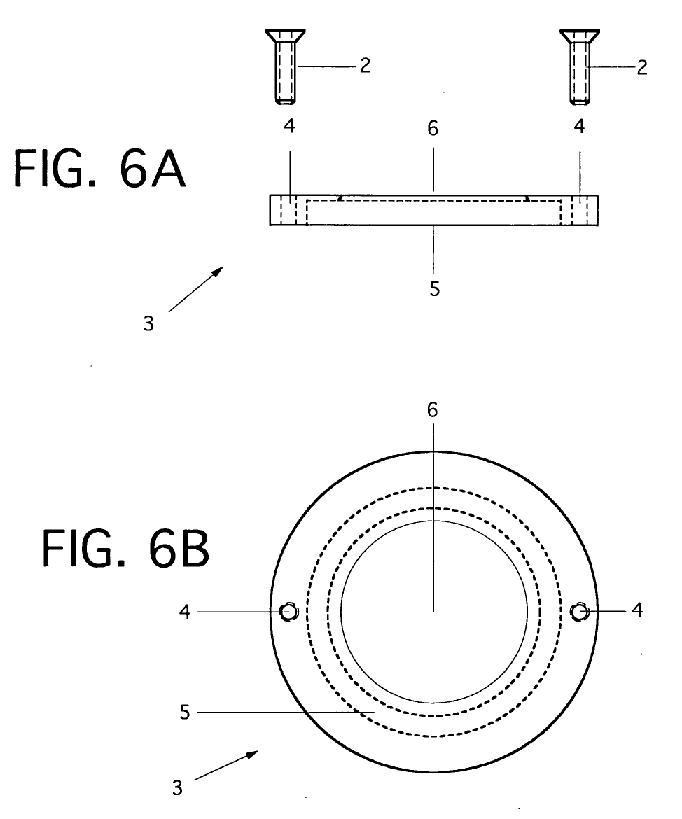

The topcap 3 (FIGS. 6A and 6B) secures the stem nut 26 and the collet 17 within the clampbar 7. Among other functions, the topcap 3 retains the stem nut 26 in location, preventing dirt and debris from entering the overall collet assembly, and maintaining the clamp 1 as a single piece unit.

As shown in FIGS. 6A-6B, the topcap 3 includes two or more tapered apertures 4 extending therethrough. The topcap 3 includes suitable fasteners such as threaded screws 2 which pass through the apertures 4 in the topcap 3 and engage the threaded aperture 14 in the clamp bar 7 to secure the topcap 3 in position. One end of the topcap 3 contains an aperture 5. intentionally formed to be similar in size to the stem nut 26 which allows the stem nut 26 to partially penetrate the opening 6 (FIGS. 6A, 6B). One purpose of the aperture 5 is to retain the stem nut 26, thereby limiting penetration of debris or dirt.

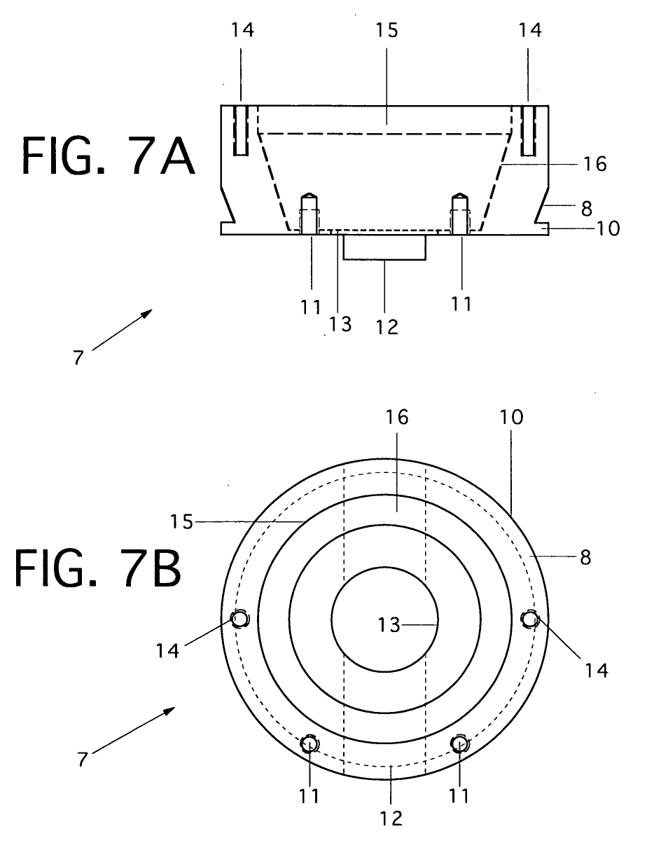

FIGS. 7A and 7B show side and top views respectively of the clamp bar 7, which moves along the shank of the fastener 39 to engage and disengage the workpiece 44. The clamp bar 7 is generally circular in shape and includes an aperture 13 extending therethrough. The aperture 13 is intentionally only slightly larger than the fastener 39, is also generally circular in shape, and sits in close contact with the stem nut 26 and collet 17, thereby keeping dirt and debris from entering the clampbar 7.

As shown in FIG. 7A & 7B, a collet aperture 16 contained within clamp bar 7 is generally conical in shape, with an enlarged area 15 opposite the aperture 13. The collet 17 is contained within this conical aperture 16. A conical aperture 16 provides the means to close the collet 17 upon action of the stem nut 26. The conical aperture 16 is designed to be similar in taper to the collet 17.

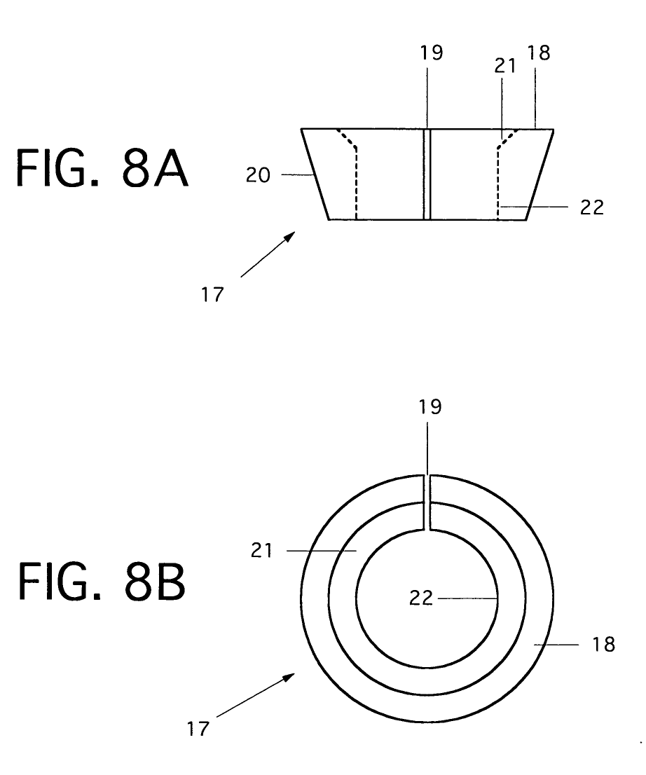

FIGS. 8A and 8B show the split-ring collet 17, which in actual use is engaged by both the stem nut 26 on one end, and the clamp bar 7 on the other. The split-ring collet 17 may incorporate a singular or plurality of slits 19 therein, for separating it into equal pieces. Such separation may help reduce stress and provide for a more equal distribution of forces. The tapered exterior 20 slides up and down into the interior taper 16 of the clamp bar 7 when acted on by the stem nut 26 during tightening and loosening. Such tightening and loosening should preferably be performed by a wrench, as hand-tightening will not generate sufficient torque to lock the stem nut 26 into place.

The action of the collet 17 is to compress under the forces exerted by the taper 16 and the bottom of the stem nut flange 25, and also to encircle and inhibit the rotation of the stem nut 26. This causes the collet 17 to contact and therefore restrict rotation of the stem nut 26 during tightening. Ideally, such restriction of rotation will occur only when a sufficient clamping force has occurred between the clamp bar 7 and the work surface.

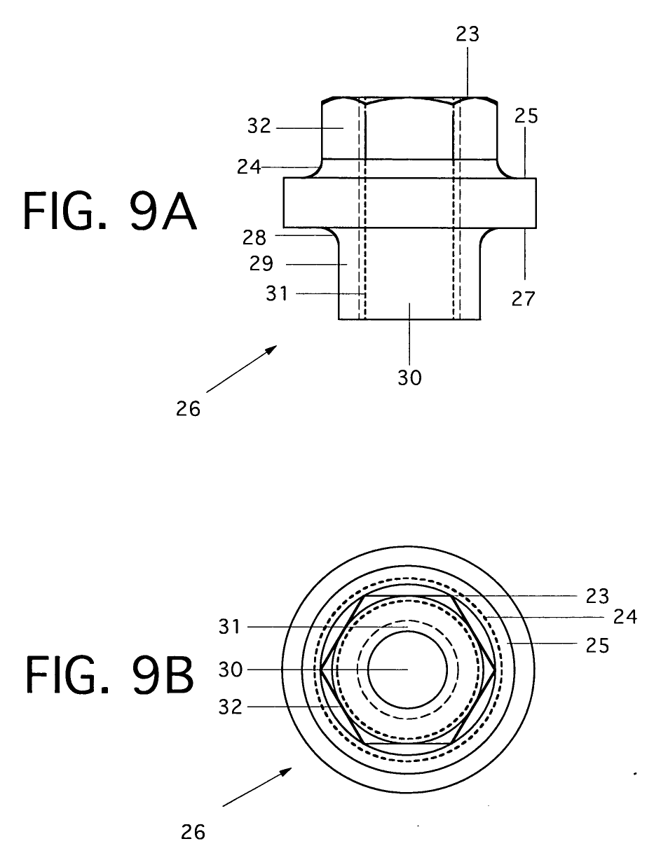

FIGS. 9A-9B show the stem nut 26, which movably and rotatably engages with the threaded end 81 to move the clamp bar 7, topcap 3, collet 17 and heelblock 34 as one unit along the threaded end 81 of the fastener 39. To achieve this, the stem nut 26 includes a protrusion 23 which can be cylindrical in shape and has a plurality of wrench flats 32 to form a shape suitable for allowing a tool to engage and rotate it. Contained on the nut 26 beside the wrench flats 32 is a cylindrical flange 25 extending radially outward from the stem nut 26 which is larger than the remainder of the stem nut 26, yet smaller than but similar in thickness to the combined apertures 5 and 15. The stem nut 26 also has an aperture 30 extending therethrough and being threaded 31 to engage with the threaded end 81.

The stem nut 26 further includes a stem 29 extending axially from the flange 25. As shown in FIG. 7, the stem 29 can have a generally circular and tubular shape extending somewhat from the flange 25 of the stem nut 26 opposite the flange 25. The stem 29 provides the location for the collet 17 to contact during tightening and active use. The stem 29 also acts to restrict the further rotation of the stem nut 26 when optimum clamping force is achieved. The stem nut 26 also contains radiused corners 24 and 28 (FIGS. 7 and 8) to reduce point-loaded corners. Reducing point-loaded corners extends the useful life of the clamp 1 by eliminating stress-points that can cause the material of the clamp 1 to fatigue and fail after repeated usages.

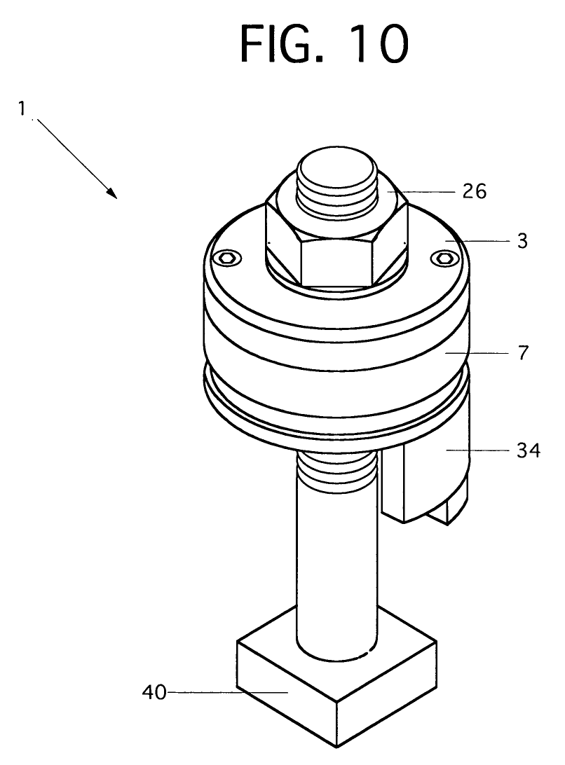

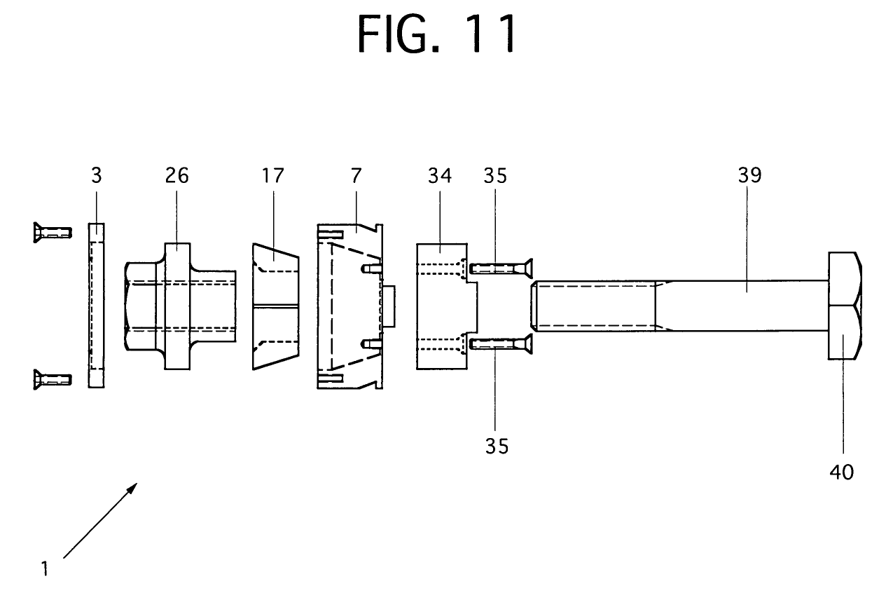

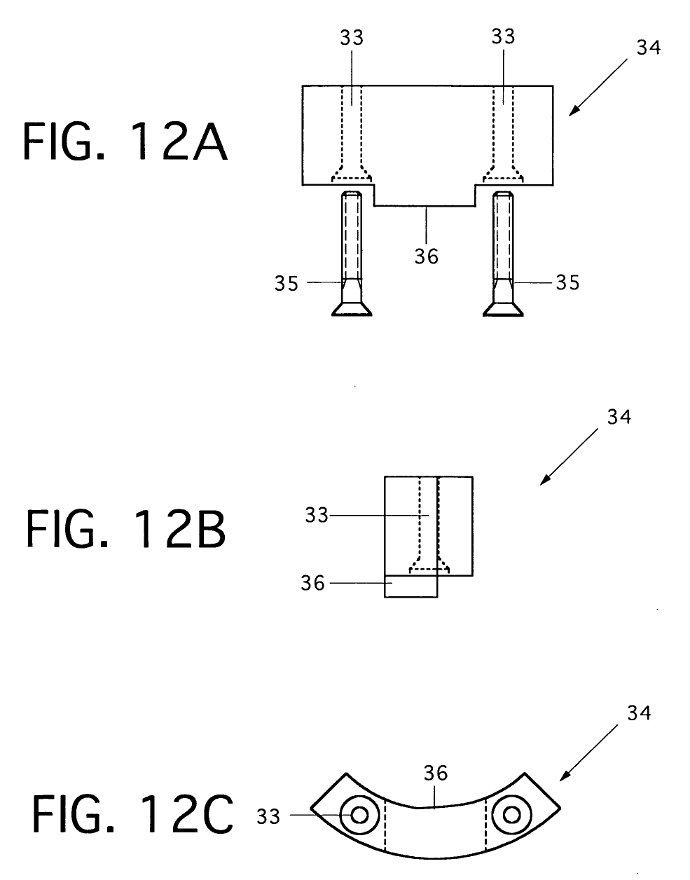

Under certain circumstances, it may be necessary to add a heelblock to the clamp 1, such as when used with an unslotted die shoe. To that end, FIGS. 10-11 show the clamp 1 with a heelblock 34 incorporated therein. As shown in FIGS. 12A-12C, the heelblock 34 has a predetermined height to allow the clamp bar 7 to remain substantially planar when engaged with an unslotted die shoe 38. The heelblock 34 is generally semi-circular in shape and may have a guide 36 extending outwardly at one end. The guide 36 is generally rectangular in shape and facilitates slidable movement within the slots 42. The heelblock 34 may be located at the outer diameter of the clamp bar 7 to move the pressure center of the heelblock 34 away from the center line of the fastener 39.

It should be appreciated that the increased distance between the heelblock 34 and the center line of the fastener 39 has the effect of increasing the force of the clamp 1 on the workpiece 44, as compared to a heelblock located beside the fastener 39. To facilitate this, the heelblock 34 includes at least one, and preferably a pair of apertures 33 extending therethrough. The heelblock 34 is secured to the clamp bar 7 by suitable means such as threaded fasteners 35, which pass through the aperture 33 and engage threaded aperture 11 in the clamp bar 7.

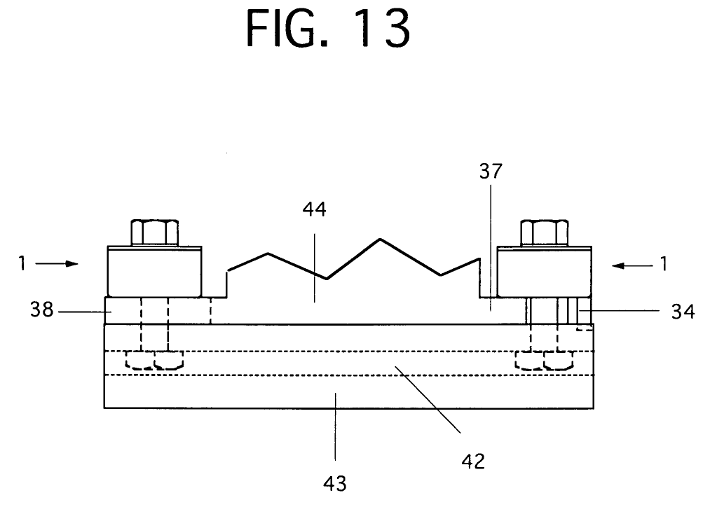

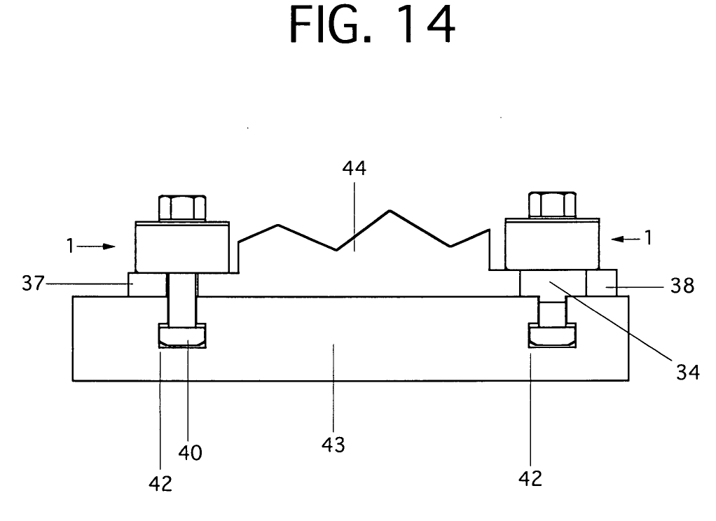

FIG. 13 is a side view of one possible configuration the press 65, and FIG. 14 is a front view of FIG. 13. As illustrated in FIGS. 13-14, the clamp(s) 1 may be used for securing an item such as a slotted die shoe 37 or unspotted die shoe 38 to the workpiece 44 within the press 65. The work surface 43 of the press 65 includes at least one and preferably a plurality of generally T-shaped slots 40. These T slots 40 will vary in width according to the size of the press 65.

Referring to FIG. 13 and 14, the head 40 also has a width less than a width of the slots 42 to allow the head 40 to slide in the slots 42, but still has sufficient width to prevent damage to interior corners of the slots 42 during the inevitable turning of the head 40 when tightening the stem nut 26. The shaft 39 may also have a relief portion (not shown) to provide the shaft with a diameter width to allow the head to have a larger width than conventional fasteners. The fastener 39 is anchored in the slot by the head 40.

If the clamp 1 is used to clamp to an unslotted die shoe 38, the clamp 1 will include the heelblock 34. Conversely, if the clamp 1 is to be used with a slotted die shoe 37, the heelblock 34 may be omitted.

### Method of Assembling the Present Invention

Referring now to FIGS. 1-2, to assemble the clamp 1, preferably the stem nut 26 is disposed in the split ring collet 17, then inserted into the clamp bar 7 recess, and is then aligned with the aperture 15. The stem nut 26 is inserted in the aperture 6. After such insertion, the collet 17 will contact the opposing conical relief 16 of the clamp bar 7, which allows movement of the stem nut 26 axially within the clamp bar 7. The topcap 3 is then applied to the clamp bar 7 with the fasteners 2. In this manner, the stem nut 26, topcap 3, and clamp bar 7 and collet 17 are a single integrated unit or assembly such that the stem nut 26 may freely rotate. It is important that the stem nut 26 not be hindered in movement, otherwise it will be difficult to assemble/disassemble and install/uninstall the clamp 1.

Once assembled, the fastener 39 is inserted through clamp bar aperture 13 and threaded into the threads 31 of aperture 30. The stem nut 26 can then be rotated so as to move axially along the threaded end 81 of the fastener 39, thereby tightening the clamp 1.

### Method of Using the Present Invention

In operation, the head 40 of the fastener 39 is disposed in a slot 42 of the workpiece 44, as shown in FIGS. 13 and 14. The clamp 1 is moved until the clamp bar 7 is partially or entirely disposed over the workpiece 44. The stem nut 26 is then rotated to move the clamp bar 7 toward the work surface 37 or 38 such that the clamp bar 7 engages or snugs down on the workpiece 44. At that point, the stem nut 26 is rotated further, perhaps 180 degrees, preferably with a tool such as a wrench, to develop a desired clamping force on a work surface 43. As the clamping force develops on the workpiece 44, the tapered side 20 of the split-ring collet 17 and the opposing, somewhat similar taper 16 of the clamp bar 7 engage to constrict the collet 17. When the desired clamping force is achieved, the compressional engagement between the collet 17 and stem nut 26 prevents further rotation of the stem nut 26, but also restricts it from loosening during operation but still maintains a clamping force on the workpiece 44.

To remove the clamp 1, the stem nut 26 is rotated in the opposite direction. This causes the collet 17 to open and thereby relieve pressure upon the stem nut 26, bringing the pressure down to a level preferably equal to that exerted on a standard threaded nut. As rotation occurs, the clamp bar 7 distances itself from the workpiece 44, thereby releasing clamping pressure on the work piece 44. As the stem nut 26 is rotated further, it moves along the threaded end 81 and away from the work piece 44 such that the clamp bar 7 eventually disengages the workpiece 44.

It should be appreciated that to entirely release the clamp, the stem nut 26 need be turned only slightly, just enough to clear the workpiece 44. A user can then quickly remove the clamp 1 and re-insert, hence the name “quick die change collet clamp”.

As shown in FIGS. 1 and 2, the clamp 1 combines a fastener 39, stem nut 26, clamp bar 7, collet 17 and topcap 3 into a single combined unit or assembly thereby saving time in clamping the work piece 44 to the surface of the press 65. Significant time is saved by eliminating any need to handle various bars, loose washers, or other things that are normally attached to a typical clamp. The clamp 1 also removes the possibility of loose washers and nuts from being left in the operating area of the press, which can cause damage to the dies during operation of the press. The clamp 1 also provides a single, unified, easily manipulated device, because the fastener 39, clamp bar 7, collet 17, topcap 3 and stem nut 26 remain attached to one another during clamping, unclamping and even storage. However, the clamp 1 can still be quickly disassembled to be cleaned, repaired, or have parts replaced.

The present invention has been described in an illustrative manner. It is to be understood that the terminology which has been used is intended to be in the nature of words of description rather than of limitation. Also, many modifications and variations of the present invention are possible in light of the above teachings. Therefore, within the scope of the appended claims, the present invention may be practiced otherwise than as specifically described. Accordingly, it is anticipated that various changes may be made in the arrangement and operation of the system of the present invention without departing from the spirit and scope of the invention, as defined by the following claims.

What is claimed is:

1. A clamp for use within a press, comprising:
a cylindrical fastener having a head end and a threaded end;
a clamp bar having a circular aperture at its center for admitting the fastener, where the clamp bar faces the head end of the fastener;
a collet having a circular aperture at its center for admitting the fastener, where the collet adjoins the clamp bar such that the clamp bar is closest to the head end of the fastener;
a stem nut having a threaded circular aperture at its center thereby forming a mechanical connection with the threaded end of the fastener, where the stem nut adjoins the collet such that the collet is between the stem nut and the clamp bar; and
a topcap having a circular aperture at its center for admitting the fastener, where the topcap adjoins the stem nut and acts to hold the stem nut in position, such that the stem nut is between the topcap and the head end of the fastener.

2. The clamp of claim 1, wherein the fastener comprises a large bolt.

3. The clamp of claim 1, further comprising:
the fastener has a shaft extending longitudinally with a generally circular cross-section.

4. The clamp of claim 1, wherein the head end is rectangular or square in cross-section.

5. The clamp of claim 1, further comprising:
the topcap secures the stem nut and the collet within an interior aperture of the clampbar.

6. The clamp of claim 5, further comprising:
the topcap includes two or more tapered apertures extending therethrough, for admitting securing means.

7. The clamp of claim 1, further comprising:
the clamp bar moves along the shaft of the fastener to engage and disengage a workpiece that is being shaped by the press.

8. The clamp of claim 1, wherein the clamp bar contains a collet aperture which is generally conical in shape, and also has an enlarged area opposite the collet aperture for containing the collet.

9. The clamp of claim 1, further comprising:
the conical aperture provides means to close the collet depending on action of the stem nut.

13. The clamp of claim 1, further comprising:
the collet is engaged by both the stem nut on one end and the clamp bar on the other end.

14. The clamp of claim 13, further comprising:
the collet is a split-ring collet.

15. The clamp of claim 13, further comprising:
the collet may incorporate a singular or plurality of slits therein, for separating it into equal pieces.

16. The clamp of claim 1, further comprising:
the collet has a tapered exterior which slides up and down into the interior taper of the clamp bar.

17. The clamp of claim 1, further comprising:
the stem nut movably and rotatably engages with the threaded end to move the clamp bar, topcap, collet, and heelblock as one unit along the threaded end of the fastener.

18. The clamp of claim 1, further comprising:
the stem nut has a plurality of wrench flats to form a shape suitable for allowing a tool to engage and rotate it.

19. The clamp of claim 1, wherein the stem nut further comprises:
a stem, formed by a cylindrical protrusion having a generally circular and tubular shape, thereby extending the circular aperture.

20. The clamp of claim 19, further comprising:
the stem provides a location for the collet to contact during tightening and actual use.

21. The clamp of claim 20, further comprising:
the stem restricts rotation of the stem nut when optimum clamping force is achieved.

22. The clamp of claim 20, further comprising:
the stem contains radiused corners.

23. The clamp of claim 1, further comprising:
a heelblock, having a circular aperture for admitting the fastener, located between the clamp bar and head end, having a predetermined height for allowing the clamp bar to remain substantially planar when engaged with irregularly-shaped item.

24. The clamp of claim 23, wherein the irregularly-shaped item is an unslotted die shoe.

25. The clamp of claim 23, further comprising:
the heelblock is semi-circular shaped.

26. The clamp of claim 23, further comprising:
a guide connected to the heelblock, rectangular in shape, for facilitating slidable movement within various slots located within the press.

27. The clamp of claim 1, wherein the shaft further comprises:
a relief portion to provide the shaft with a diameter width to increase the width of the head end.

28. A method of assembling a clamp, comprising:
locating a stem nut inside a collet;
inserting the combination into a clamp bar recess;
aligning the combination with an aperture;
inserting a stem nut within the aperture;
the insertion causing the collet to contact the opposing conical relief of the clamp bar; thereby
allowing movement of the stem nut axially within the clamp bar; and
applying a topcap to the clamp bar, so that the stem nut, topcap, clamp bar, and collet are a single integrated unit that all moves together along a shaft of a fastener.

29. A method of installing a clamp, comprising:
inserting a fastener through an aperture within a clamp bar;
inserting the fastener through an aperture within a collet;
inserting a threaded potion of the fastener into a threaded aperture within a stem nut, so that the clamp bar, collet, and stem nut all move together as a single combined clamp-unit along the axis of the fastener;
rotating the combined clamp; thereby
moving the combined clamp axially along the threaded end of the fastener thereby tightening it against a workpiece;
locating a head of the fastener within a slot of the workpiece;
moving the combined clamp until the clamp bar is partially or entirely disposed over the workpiece;
rotating the stem nut; thereby
moving the clamp bar toward the workpiece such that the clamp bar engages or snugs down on the workpiece;
further rotating the stem nut, preferably with a tool such as a wrench; thereby
developing a clamping force on the workpiece; and
halting rotation of the stem nut when the clamping force reaches a predetermined threshold as determined by a user.

29. The method of claim 28, further comprising:
as the clamping force develops on the workpiece, engaging a tapered side of the collet with an opposing taper of the clamp bar; thereby constricting the collet such that when the desired clamping force is achieved, further rotation of the stem nut is prevented; and
restricting the combined clamp-unit from loosening during operation yet still maintaining the clamping force at the predetermined threshold.

30. A method of removing a clamp, comprising:
rotating a stem nut thereby causing a collet to open and thereby relieve pressure upon the stem nut,
bringing a clamping pressure down to a level equivalent to that exerted on a standard threaded nut;
as rotation of the stem nut occurs, distancing a clamp bar from a workpiece; thereby
releasing clamping pressure on the workpiece;
further rotating the stem nut so that the clamp bar eventually disengages from the workpiece;
rotating the stem nut slightly, just enough to clear the workpiece; thereby
entirely releasing the clamp.
